(19) United States
(12) Patent Application Publication
(10) Pub. No.: US 2026/0119588 A1
(43) Pub. Date: Apr. 30, 2026

(54) CITED LITERATURE SUGGESTION SYSTEM

(71) Applicant: SEMICONDUCTOR ENERGY LABORATORY CO., LTD., Atsugi-shi (JP)

(72) Inventors: Junpei MOMO, Sagamihara (JP); Mayumi MIKAMI, Atsugi (JP)

(21) Appl. No.: 19/355,127

(22) Filed: Oct. 10, 2025

(30) Foreign Application Priority Data
Oct. 24, 2024 (JP) 2024-187301

(51) Int. Cl. G06F 16/9535; G06F 16/9538

(52) U.S. Cl. CPC G06F 16/9535; G06F 16/9538

(57) ABSTRACT

A cited literature suggestion system including an input/output device, a memory device, a first information processing device, and a second information processing device is provided. The second information processing device is configured to perform processing using a foundation model. The first information processing device is configured to search the memory device with use of a portion needing citation in received text as a query and to create a first prompt with use of first literature come up through the search. The first prompt includes an instruction to confirm whether or not the first literature is appropriate as cited literature for the portion needing citation, to confirm whether a portion relating to the portion needing citation in the first literature is cited from second literature when the first literature is appropriate, and to provide information on the second literature when the second literature is used for the citation.

### BACKGROUND OF THE INVENTION

### 1. Field of the Invention

One embodiment of the present invention relates to an information processing method, an information processing device, and an information processing system. One embodiment of the present invention relates to an information processing method and an information processing system each of which utilizes a foundation model. Specifically, one embodiment of the present invention relates to a cited literature suggestion system and a text creation support system each of which utilizes a foundation model.

Note that one embodiment of the present invention is not limited to the above technical field. Examples of the technical field of one embodiment of the present invention include a semiconductor device, a display device, a light-emitting device, a power storage device, a memory device, an electronic device, a lighting device, an input device (e.g., a touch sensor), an input/output device (e.g., a touch panel), a method for driving any of them, and a method for manufacturing any of them.

### 2. Description of the Related Art

When logical text is created, any literature is sometimes cited. The purpose of citing the literature is to reinforce an author's own opinion and provide its evidence in many cases, but the purpose is to omit a complicated explanation of an experimental approach to make concise text in some cases. Citing appropriate literature is required particularly in papers in the fields of natural science, and the like. It is not at all unusual that 50 or more literatures are cited in original articles and review articles.

Meanwhile, it is not easy for many authors to accurately comprehend a large amount of cited literature and the contents of the potential cited literature. Thus, a plurality of ideas on support systems for writing academic papers or citing literature have been proposed. For example, Patent Document 1 proposes a service that can search for a technique that is identical or similar to the technique described in part of the text and provide prior literature suitable for cited literature.

### Reference

[Patent Document 1] Japanese Published Patent Application No. 2022-153673

### SUMMARY OF THE INVENTION

Authorized people including authors are associated with various difficulties in writing logical text, confirming it, and the like. For example, as the number of portions where cited literature is needed are increased, it becomes difficult to select and comprehend all literature to be cited appropriately. Furthermore, there is a limitation on the text length, the number of words, and the amount of cited literature in academic papers, in some cases; proper selection of the cited literature is an important issue.

Moreover, in the academic papers and the like, it is necessary to describe the background with history traced back. There is a risk that an appropriate evaluation is not obtained unless sentences for describing the background, the positioning of an achievement, and the like are constructed, even if experimental data showing remarkable results is gained.

In view of the above, an object of one embodiment of the present invention is to provide at least one of a system, software, an information processing device, and a citation support method which suggests cited literature appropriate for certain text. Another object is to provide at least one of a system, software, an information processing device, and a text creation support method which suggests text appropriate for certain experimental data. Another object is to provide at least one of a system, software, an information processing device, and a method which supports an author or the like, who is a user, in creating text, confirmation thereof, or the like.

Note that the description of these objects does not preclude the existence of other objects. In one embodiment of the present invention, there is no need to achieve all of these objects. Other objects will be apparent from and can be derived from the description of the specification, the drawings, the claims, and the like.

One embodiment of the present invention is a cited literature suggestion system including an input/output device, a memory device, a first information processing device, and a second information processing device. The input/output device is configured to receive text; the memory device is configured to store a plurality of pieces of registered literature; the second information processing device is configured to perform processing using a foundation model; and the first information processing device is configured to search the memory device with use of a portion needing citation in the received text as a query, to create a first prompt with use of first literature come up through the search, and to input the first prompt to the second information processing device. The first prompt includes an instruction to confirm whether or not the first literature is appropriate as cited literature for the portion needing citation, to confirm whether a portion relating to the portion needing citation from the first literature is cited from second literature when the first literature is appropriate, and to provide information on the second literature when the second literature is used for the citation. The input/output device is configured to display the portion needing citation in the text, the first literature, and the second literature provided by the second information processing device.

In the above, the first information processing device is preferably configured to create a second prompt and to input the second prompt to the second information processing device, and the second prompt preferably includes an instruction to extract a portion needing citation from the text.

In the above, the input/output device is configured to display a suggestion provided by the first information processing device and to receive literature, and the first information processing device preferably provides the input/output device with a suggestion for obtaining third literature and registers the third literature in the memory device.

In the above, the input/output device is preferably further configured to receive a plurality of pieces of experimental data, the first information processing device is preferably configured to create a third prompt with use of the plurality of pieces of received experimental data and to input the third prompt to the second information processing device, the third prompt preferably includes an instruction to create an introduction suitable for an academic paper presenting the plurality of pieces of experimental data from information included in the plurality of pieces of experimental data, and the input/output device is preferably configured to display the introduction created by the second information processing device.

In the above, the introduction is preferably used as text.

In the above, the first information processing device is preferably configured to search the memory device with use of the portion needing citation in the text as a query, to create a fourth prompt when no literature comes up, and to input the fourth prompt to the second information processing device. Furthermore, the fourth prompt preferably includes an instruction to create a search formula including a term and a synonym for the portion needing citation in the text, and the first information processing device preferably provides the input/output device with a suggestion for obtaining the third literature with use of the search formula created by the second information processing device and registers the third literature in the memory device.

One embodiment of the present invention can provide at least one of a system, software, an information processing device, and a citation support method which suggests cited literature suitable for certain text. Another embodiment can provide at least one of a system, software, an information processing device, and a text creation support method which suggests text suitable for certain experimental data. Another embodiment can provide at least one of a system, software, an information processing device, and a method which supports an author or the like, who is a user, in creating text, confirmation thereof, or the like.

Note that the effects of one embodiment of the present invention are not limited to the effects listed above. The effects listed above do not preclude the existence of other effects. The other effects are effects that are not described in this section and are described below. The other effects will be apparent from and can be derived from the description of the specification, the drawings, and the like by those skilled in the art. One embodiment of the present invention is to have at least one of the aforementioned effects and the other effects. Therefore, one embodiment of the present invention does not have the effects described above in some cases.

### BRIEF DESCRIPTION OF THE DRAWINGS

FIG. 1A is a diagram describing an example of a cited literature suggestion system, and FIG. 1B is a diagram describing an example of a first information processing device.

FIG. 2 is a flow chart showing an example of a processing method of a cited literature suggestion system.

FIG. 3 is a flow chart showing an example of a processing method of a cited literature suggestion system.

FIG. 4 is a flow chart showing an example of a processing method of a cited literature suggestion system.

FIG. 5 is a flow chart showing an example of a processing method of a cited literature suggestion system.

FIG. 6 is a flow chart showing an example of a processing method of a cited literature suggestion system.

### DETAILED DESCRIPTION OF THE INVENTION

Embodiments will be described in detail with reference to the drawings. Note that the present invention is not limited to the following description and it will be readily appreciated by those skilled in the art that modes and details can be modified in various ways without departing from the spirit and the scope of the present invention. Accordingly, the present invention should not be construed as being limited to the description in the following embodiments.

Note that in the structures of the invention described below, the same portions or portions having similar functions are denoted by the same reference numerals in different drawings, and description of such portions is not repeated.

Note that in this specification, ordinal numbers such as first, second, and third are used in order to avoid confusion among components, and the terms do not limit the components numerically.

### Embodiment 1

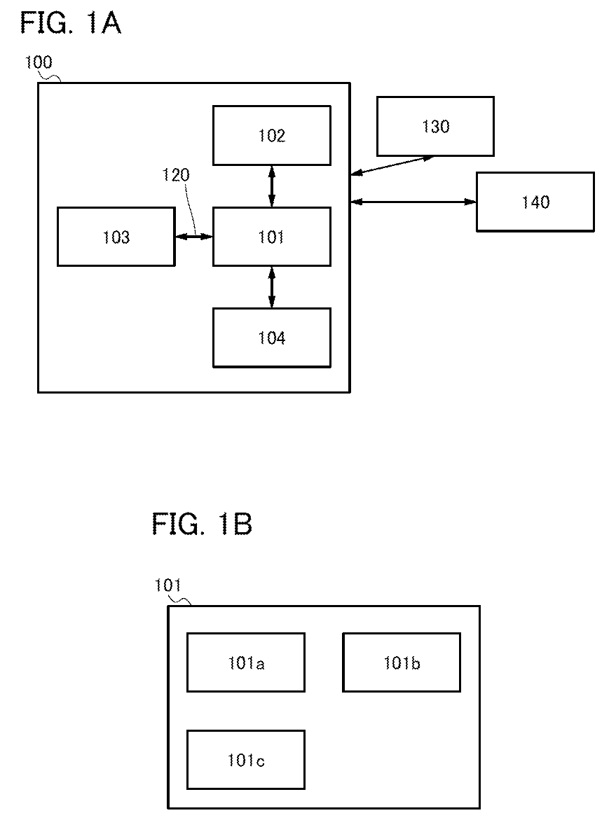

In this embodiment, a cited literature suggestion system of one embodiment of the present invention will be described with reference to FIGS. 1A and 1B, FIG. 2, FIG. 3, FIG. 4, FIG. 5, and FIG. 6.

### Cited literature suggestion system

The cited literature suggestion system of one embodiment of the present invention is a system for supporting creation of logical text with suggestion of cited literature suitable for certain text and/or suggestion of text suitable for certain experimental data.

The cited literature suggestion system includes at least an information processing device. FIG. 1A illustrates a structure of a cited literature suggestion system 100. The cited literature suggestion system 100 includes a first information processing device 101, a second information processing device 102, an input/output device 103, and a memory device 104. Although the block diagram in drawings attached to this specification illustrates components classified by their functions in independent blocks, it is difficult to classify actual components by their functions completely, and one component can have a plurality of functions. Moreover, one function can relate to a plurality of components; for example, processing of the first information processing device 101 or the second information processing device 102 can be executed on a different server depending on processing.

The cited literature suggestion system 100 can be provided in an information processing device such as a computer used by a user. Alternatively, the cited literature suggestion system 100 can be provided with a server including the first information processing device 101, the second information processing device 102, the memory device 104, and the like and can be accessed from a client PC serving as the input/output device 103 via a network 120.

The input/output device 103 has a function of receiving text. Furthermore, the input/output device 103 preferably has a function of receiving literature and a function of receiving a plurality of pieces of experimental data. Furthermore, the input/output device 103 has a function of displaying the contents provided by the first information processing device 101 and/or the second information processing device 102 for the user. As the input/output device 103, a communication port or an input device such as a computer having a communication function may be used, for example.

In this specification and the like, text refers to one or more sentences and does not limit any language or recording medium. The text needing citation of any literature is sometimes called logical text. In this specification and the like, experimental data includes experimental results, analysis results, calculation results, text describing these results, text describing methods of the experiment, the analysis, and the calculation, text describing effects thereof, and/or text describing considerations. As an expression form of experimental data, as well as text, numerical values, diagrams, and/or tables are allowed.

The memory device 104 has a function of storing a plurality of pieces of registered literatures.

In this specification and the like, literature refers to text that might be a target for citation. The literature includes, for example, academic papers, proceedings, minutes, books, patent documents, and articles. Examples of the academic paper include original articles, review articles, rapid communications, pre-peer reviewed papers.

The second information processing device 102 has a function of performing processing using a foundation model. The foundation model can also be referred to as a large language model (LLM), a text generative model, a conversational model, or the like. An LLM is a natural language processing model learned using a large amount of data. With the foundation model, for example, an interactive model that gives an answer to a user's instruction can be achieved. For example, a foundation model such as GPT-3 (registered trademark), GPT-3.5, GPT-4 (registered trademark), Language Model for Dialogue Applications (LaMDA), Pathways Language Model (PaLM), Llama2, or Llama3 can be used.

The first information processing device 101 has a function of obtaining text received by the input/output device 103. In addition, the first information processing device 101 has a function of accessing the memory device 104 and searching the memory device 104 with use of a portion needing citation in the received text as a query. Moreover, the first information processing device 101 has a function of creating a first instruction sentence that is to be input to the second information processing device 102, with use of a first literature come up through the search. In this specification and the like, an instruction sentence is also referred to as a prompt.

The first information processing device 101 further has functions of inputting the prompt to the second information processing device 102 and obtaining an output from the second information processing device 102. Furthermore, the first information processing device 101 has a function of providing information obtained from the output to the input/output device 103.

The portion needing citation in the text can be specified in advance by the user, for example.

The first literature is literature obtained by searching the memory device 104 with use of the portion needing citation in the received text as a query, and the number of pieces of the literature is not necessarily one. Although not illustrated, the cited literature suggestion system 100 can have a function of displaying the first literature including one or more pieces of literature on the input/output device 103 and making the user select one or more pieces of literature from the first literature. In this case, the following processing can be performed using the first literature selected by the user. In this embodiment, the case where one review article is obtained as the first literature as a result of searching the memory device 104 is described.

The first prompt preferably includes an instruction to confirm whether or not the first literature is appropriate as cited literature for the portion needing citation in the text. In addition, the first prompt preferably includes an instruction to confirm whether a portion relating to the portion needing citation in the text of the first literature is further cited from second literature in the case where the first literature is appropriate as the cited literature. Furthermore, the first prompt preferably includes an instruction to provide information on the second literature in the case where the second literature is used for citation. In the case where the first literature includes a plurality of pieces of literature, it is preferable to create a plurality of first prompts corresponding to the respective pieces of literature.

The second literature is literature from which a portion relating to the portion needing citation in the text of the first literature is cited, and the number of pieces of the literature is not necessarily one.

When the first literature cites the second literature, the cited literature suggestion system 100 has a function of creating the first prompt again with use of the second literature and processing the first prompt in a manner similar to the above. In other words, the cited literature suggestion system 100 has a function of performing recursion processing until literature that does not include a relating portion needing citation from another literature comes up. In this embodiment, the following case is described: as a result of inputting the first prompt for one review article to the second information processing device 102 and obtaining an output from the second information processing device 102, one original article is obtained as the second literature whose relating portion does not need citation from another literature.

The input/output device 103 has a function of displaying the portion needing citation in the text, the first literature, and the second literature. Referring information on this, the user can determine whether or not the first literature and/or the second literature are/is appropriate as the cited literature.

In the case where the user determines that the first literature and/or the second literature are/is appropriate as the cited literature, the cited literature suggestion system 100 preferably has a function of performing processing similar to the above, on a next portion needing citation in the received text.

With use of the cited literature suggestion system 100 in such a manner, the user can obtain information on cited literature appropriate for a portion needing citation in the text. When the citation of a relating portion is traced, information on a primary source can be easily obtained. Thus, without citation of a secondary source, text with proper citation of an original article, original text, and the like can be created in a short time.

In addition, the cited literature suggestion system 100 preferably has a function of extracting the portion needing citation in the received text.

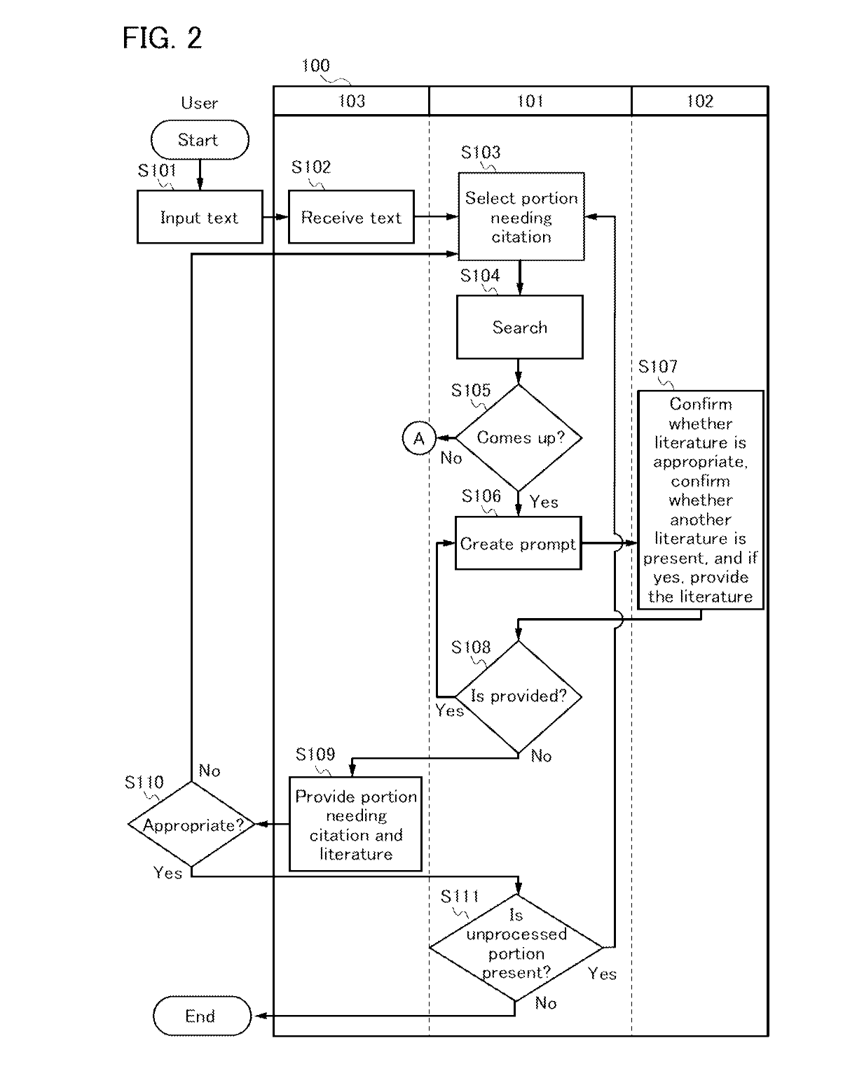

At this time, the first information processing device 101 has a function of creating a second prompt. The second prompt preferably includes an instruction to extract a portion needing citation from the text. It is further preferable that the second prompt include an example of the past successful processing, i.e., processing where the user has determined that the literature is appropriate in Step S110 (see FIG. 2) and/or the past failed processing, i.e., processing where the user has determined that the literature is not appropriate in Step S110. Accordingly, with reference to the past successful and/or failed example(s), the accuracy for extracting the portion needing citation can be enhanced.

Furthermore, the first information processing device 101 preferably has a function of using an output result from the second information processing device 102, which is obtained after inputting the second prompt to the second information processing device 102, as the query for searching the memory device 104 as described above.

Although not illustrated, the cited literature suggestion system 100 can have a function of displaying the extracted portion needing citation on the input/output device 103. Furthermore, with reference to the display, the user can specify the portion needing citation. In this case, the following processing can be performed using the portion needing citation, which is specified by the user.

Furthermore, the cited literature suggestion system 100 preferably has a function of suggesting obtaining third literature when the user determines that the first literature and/or the second literature are/is not appropriate as cited literature.

The third literature is literature not registered in the memory device 104, and the number of pieces of the literature is not necessarily one. The user can obtain the third literature from the Internet, another database, or the like, for example. The input/output device 103 preferably has a function of providing a suggestion for obtaining the third literature and a function of receiving the third literature obtained by the user. The first information processing device 101 preferably has a function of registering the received third literature in the memory device 104.

The cited literature suggestion system 100 preferably has a function of performing processing similar to the above with use of the portion needing citation as a query again after the third literature is registered in the memory device 104.

The cited literature suggestion system 100 preferably has a function of creating an introduction suitable for certain experimental data. In this case, the first information processing device 101 preferably has a function of creating a third prompt. The third prompt preferably includes an instruction to create an introduction suitable for an academic paper presenting a plurality of pieces of experimental data on the basis of information included in the plurality of pieces of experimental data. The input/output device 103 preferably has a function of displaying the introduction created by the second information processing device 102.

The cited literature suggestion system 100 preferably has a function of using the created introduction described above as received text. In other words, the cited literature suggestion system 100 preferably has a function of extracting the portion needing citation from the created introduction.

The cited literature suggestion system 100 preferably has a function of supporting a user's literature search and/or literature acquisition in the case where the first literature does not come up in searching the memory device 104.

In this case, the first information processing device 101 preferably has a function of creating a fourth prompt. The fourth prompt preferably includes an instruction to create a search formula including a term and a synonym for the portion needing citation in the text. Alternatively, the fourth prompt preferably includes an instruction to provide a keyword including a term and a synonym for the portion needing citation in the text.

The first information processing device 101 preferably has a function of providing, to the input/output device 103, a suggestion for obtaining the third literature with use of the search formula created by the second information processing device 102.

FIG. 1B illustrates a structure of the first information processing device 101. As illustrated in FIG. 1B, the first information processing device 101 preferably includes a data processing unit 101a, a prompt processing unit 101b, and a display processing unit 101c.

The data processing unit 101a has a function of accessing the memory device 104 to obtain data from and registering data in the memory device 104.

The prompt processing unit 101b has a function of creating a prompt to be input to the second information processing device 102. Furthermore, the prompt processing unit 101b has a function of obtaining an output from the second information processing device 102 to generate or extract data. For example, the prompt processing unit 101b has a function of creating data relating to display created in the display processing unit 101c, extracting data to be registered in the memory device 104, or the like.

The display processing unit 101c has a function of creating a display content to be shown in the input/output device 103 and obtaining the content received by the input/output device 103.

Although the portions of the first information processing device 101 illustrated in FIG. 1B are classified according to the functions of the first information processing device 101 and independent of each other, some or all of the functions of the first information processing device 101 are not necessarily independent. The structure of the processing unit of one embodiment of the present invention is not limited to the structure of the first information processing device 101 illustrated in FIG. 1B.

The network 120 illustrated in FIG. 1A is a computer network such as the Internet, which is the infrastructure of the World Wide Web (WWW), an intranet, an extranet, a personal area network (PAN), a local area network (LAN), a campus area network (CAN), a metropolitan area network (MAN), a wide area network (WAN), or a global area network (GAN). Note that the network 120 includes wired or wireless communication. Furthermore, the network 120 includes a bus such as a Universal Serial Bus (USB) and near field communication such as Bluetooth (registered trademark).

The cited literature suggestion system 100 may be connected to an input device 130 and an output device 140 via the network 120.

The input device 130 has a function of inputting experimental data, literature, text, and the like. As the input device 130, a keyboard, a pointing device, a touch panel, an image scanner, a digital camera, can be used, for example.

The output device 140 has a function of outputting data from the first information processing device 101. As the output device 140, a printer, an audio output device, a memory, a display, a projector, or the like can be used, for example.

The above is the description of the structure and functions of the cited literature suggestion system 100. Such structures and functions enable a system for suggesting cited literature suitable for certain text and a system for suggesting text suitable for certain experimental data to be provided.

### Cited literature suggestion method

Next, an example of a method for creating text with use of the cited literature suggestion system 100 of one embodiment of the present invention will be described with reference to flow charts in FIGS. 2, 3, 4, 5, and 6 which also show procedures of processing executed by the cited literature suggestion system 100 of one embodiment of the present invention.

The method for creating text in FIG. 2 includes at least Steps S101 to S111.

Step S101 shown in FIG. 2 is a step where the user inputs text. It is preferable that the portion needing citation in the text be specified by the user in advance.

Step S102 is a step where the input/output device 103 receives the text.

Step S103 is a step where the first information processing device 101 selects the portion needing citation in the received text. In the case where the text includes a plurality of portions needing citation, one portion is selected from unprocessed portions in the plurality of portions.

Step S104 is a step where the first information processing device 101 searches the memory device 104 with use of the selected portion needing citation as a query. There is no particular limitation on the search method, and for example, full-text matching search, partial matching search, and/or similar search can be used.

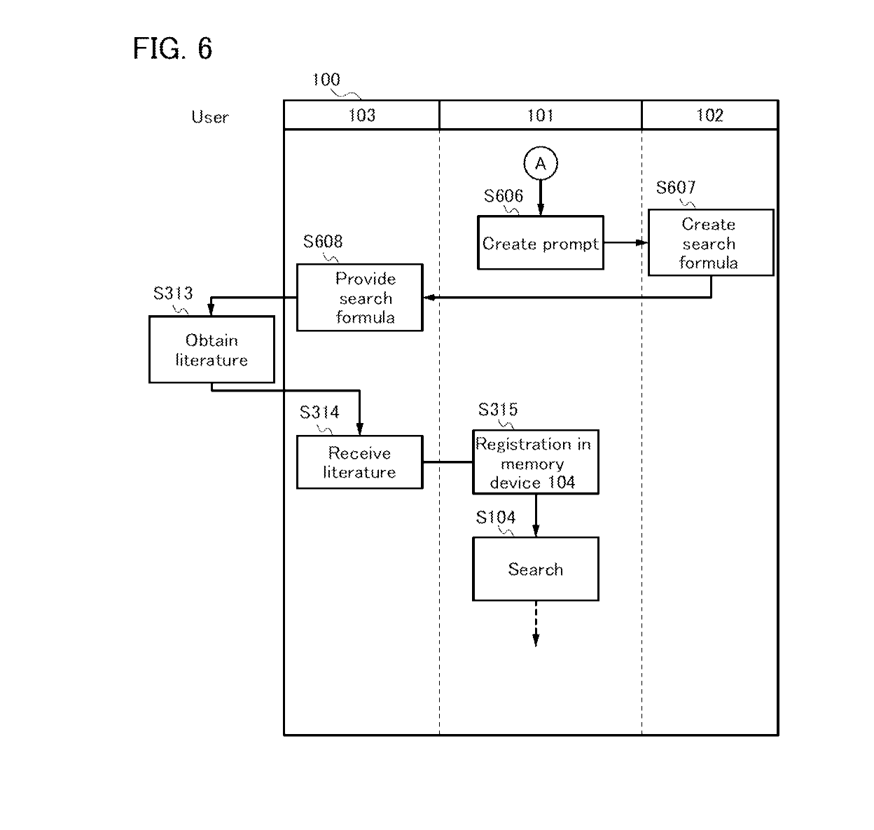

Step S105 is a step where the first information processing device 101 determines whether or not first literature comes up from a result of the search in Step S104. When the first information processing device 101 determines that the first literature comes up (Yes), the processing task proceeds to Step S106. When the first information processing device 101 determines that the first literature does not come up (No), the processing task proceeds to Step S606 in FIG. 6 in accordance with a connector A.

Step S106 in FIG. 2 is a step where the first information processing device 101 creates a first prompt and inputs it to the second information processing device 102. The first prompt preferably includes an instruction to confirm whether or not the first literature is appropriate as cited literature for the portion needing citation in the text. The first prompt further preferably includes an instruction to confirm whether a portion relating to the portion needing citation in the text of the first literature is cited from second literature when the first literature is appropriate as the cited literature. Furthermore, the first prompt preferably includes an instruction to provide information on the second literature when the relating portion is cited from the second literature. When the first literature includes a plurality of pieces of literature, a plurality of first prompts corresponding to the respective pieces of literature are preferably created.

Step S107 is a step where the second information processing device 102 outputs an answer to the input first prompt. Even when the portion needing citation in the text does not have exactly the same expression as the first literature, that is, the choice of words or the like is different between the portion needing citation and the first literature, use of a foundation model makes it possible to confirm whether or not the content of the portion needing citation corresponds to the content of the first literature. Furthermore, the use of a foundation model makes it possible to further confirm whether a portion relating to the portion needing citation in the text of the first literature is cited from the second literature.

Step S108 is a step where the first information processing device 101 obtains the output from the second information processing device 102 and confirms whether or not the second literature is provided. When the first information processing device 101 determines that the second literature is provided (Yes), the processing task returns to Step S106, and Step S106 to S108 are performed on the assumption that the second literature is the first literature. When the first information processing device 101 determines that the second literature is not provided (No), the processing task proceeds to Step S109.

Step S109 is a step where the input/output device 103 displays the portion needing citation in the text, the first literature, and the second literature. In the case where each of the first literature and the second literature includes a plurality of pieces of literature, all of them can be displayed.

Step S110 is a step where the user determines whether or not the first literature and/or the second literature are/is appropriate as cited literature, referring to the information displayed on the input/output device 103. In the case where each of the first literature and the second literature includes a plurality of pieces of literature, appropriate literature can be selected from the plurality of pieces of literature in this step. When the user determines that the first literature and/or second literature are/is appropriate (Yes) or the user selects appropriate literature, the processing task proceeds to Step S111. When the user determines that the first literature and/or second literature are/is not appropriate (No), the processing task returns to Step S103, and a next portion needing citation is selected.

Step S111 is a step where the first information processing device 101 determines whether or not a portion needing citation to be processed next is present. That is, Step S111 is a step of determining whether or not an unprocessed portion is present among the portions needing citation in the text received in the Step S102. When the first information processing device 101 determines that a portion needing citation to be processed next is present (Yes), the processing task returns to Step S103. When the first information processing device 101 determines that all portions needing citation have been processed and any unprocessed portion is not present (No), the processing ends. After Step S111, the input/output device 103 preferably displays the determination result.

With Step S101 to Step S111, the user can obtain information on cited literatures appropriate for the portions needing citation in the text. Furthermore, without use of a secondary source, text with proper citation of an original article, original text, and the like can be created in a short time.

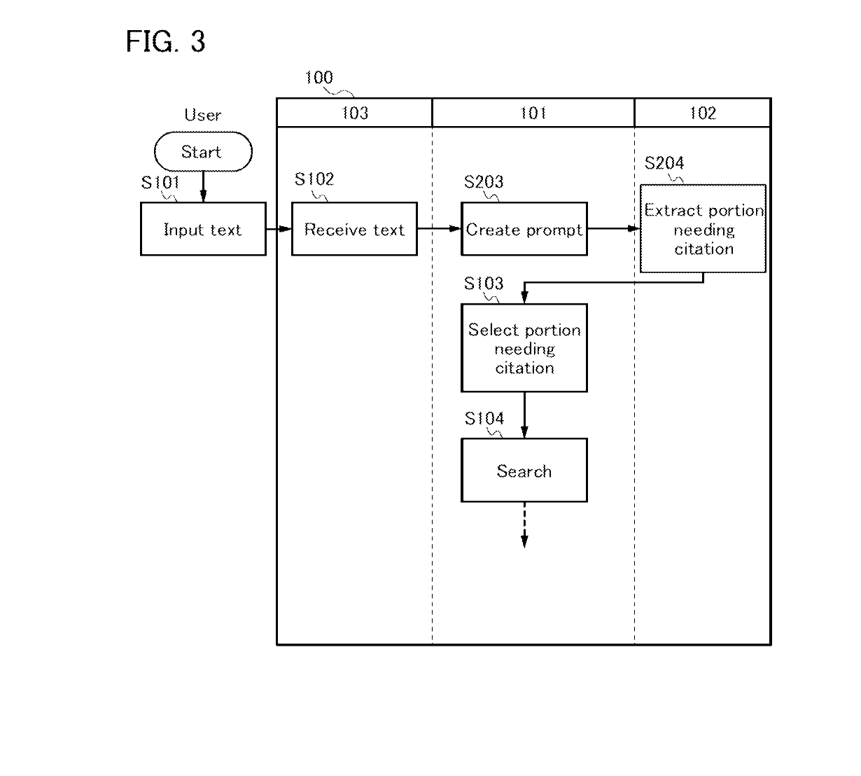

The above is the description of the cited literature suggestion method example. Note that the cited literature suggestion method of one embodiment of the present invention is not limited to the method described with reference to FIG. 2. For example, steps shown in FIG. 3 are further preferably added to the above cited literature suggestion method.

FIG. 3 is a flow chart showing Steps S203 and S204 that are added between Steps S102 and S103 shown in FIG. 2.

Step S203 is a step where the first information processing device 101 creates a second prompt and inputs it to the second information processing device 102. The second prompt preferably includes an instruction to extract a portion needing citation from the text. The second prompt further preferably includes an example of a past successful processing and/or failed processing. For example, it is preferable to include an example of processing where the past determination in Step S110 is Yes and/or No.

Step S204 is a step where the second information processing device 102 outputs an answer to the input second prompt. The first information processing device 101 can perform the processing of Step S103 using the answer.

With Steps S203 and S204, the user can obtain information on suitable cited literature without specifying the portion needing citation in the text in advance.

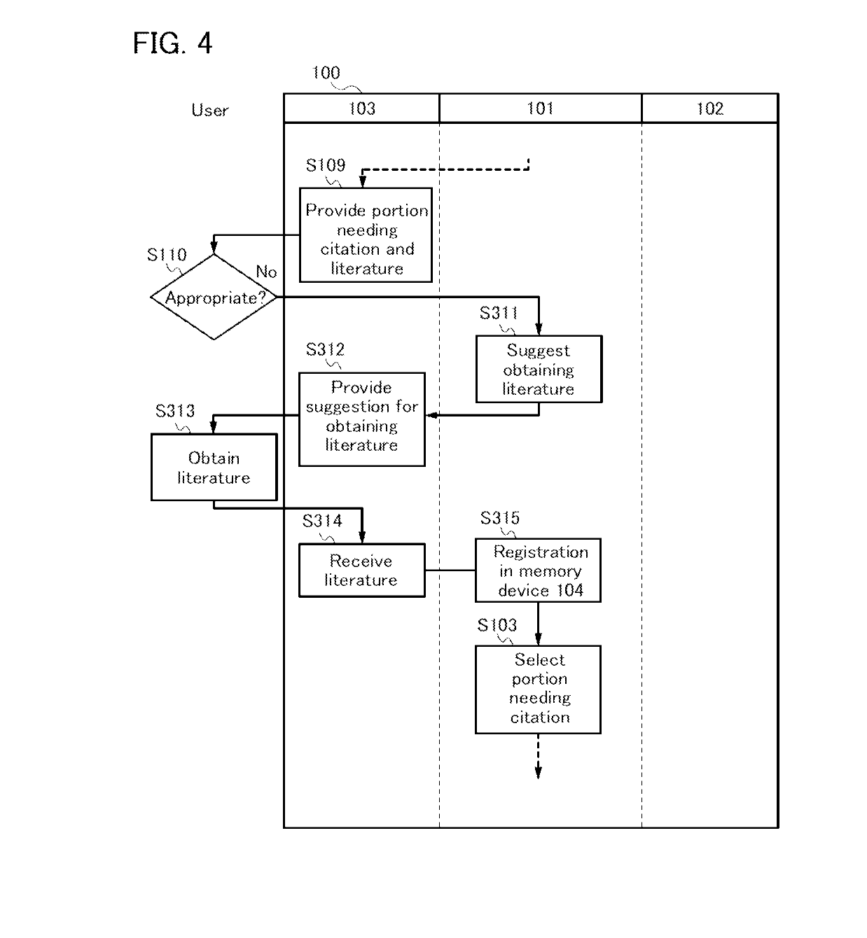

It is further preferable for establishment of the cited literature suggestion method to add steps shown in FIG. 4 to the above.

FIG. 4 is a flow chart for describing Steps S311 to S315 added between Steps S110 and S103 when the user determines that the first literature and/or the second literature are/is not appropriate as the cited reference (No) in Step S110 shown in FIG. 2.

Steps S311 and S312 are steps where the first information processing device 101 provides a suggestion of obtaining third literature to the input/output device 103.

Step S313 is a step where the user obtains the third literature. The user can obtain the third literature from the Internet, another database, or the like, for example.

Step S314 is a step where the input/output device 103 receives the third literature obtained by the user.

Step S315 is a step where the first information processing device 101 registers the received third literature in the memory device 104. After Step S315, the processing task can return to Step S104.

With Steps S311 to S315, the user can obtain information on the portion needing citation, considering new literature.

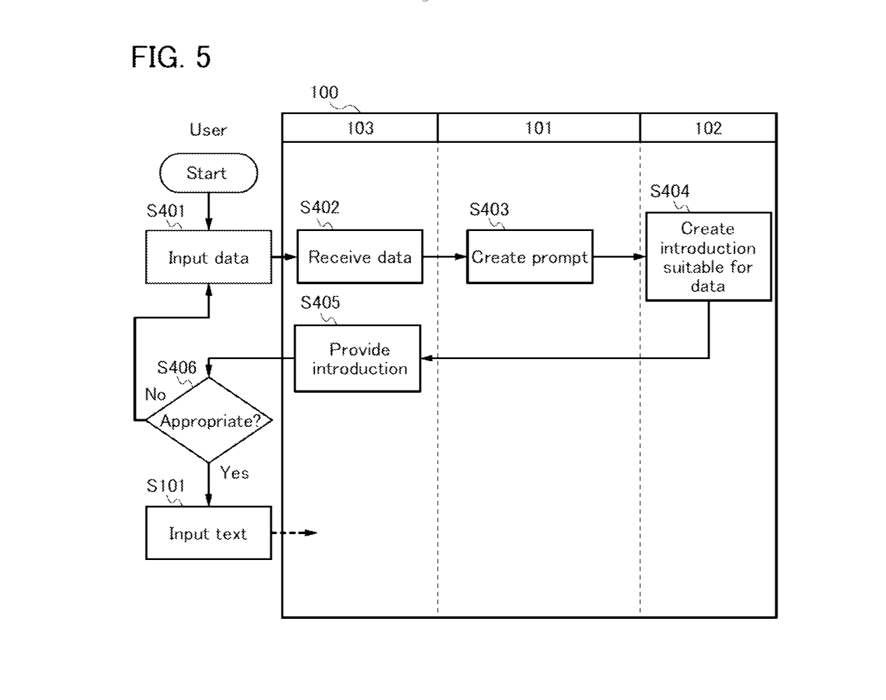

It is further preferable for establishment of the cited literature suggestion method to add steps shown in FIG. 5 to the above.

FIG. 5 is a flow chart for describing Steps S401 to S406 added before Step S101 shown in FIG. 2.

Step S401 is a step where the user inputs experimental data. As the experimental data, a plurality of pieces of data are preferable.

Step S402 is a step where the input/output device 103 receives the experimental data.

Step S403 is a step where the first information processing device 101 creates a third prompt and inputs it to the second information processing device 102. The third prompt preferably includes an instruction to create, on the basis of information included in the experimental data, an introduction suitable for an academic paper presenting the experimental data.

Step S404 is a step where the second information processing device 102 outputs an answer to the input third prompt.

Step S405 is a step where the input/output device 103 displays the introduction.

Step S406 is a step where the user determines whether or not the introduction displayed on the input/output device 103 is appropriate. When the user determines that the introduction is appropriate (Yes), the introduction can be used as the text in Step S101. When the user determines that the introduction is not appropriate (No), the processing task returns to Step S401.

With Steps S401 to S406, the user can create an introduction suitable for the experimental data and obtain information on cited literature appropriate for a portion needing citation in the introduction.

It is further preferable for establishment of the cited literature suggestion method to add steps shown in FIG. 6 to the above.

FIG. 6 is a flow chart for describing Steps S606 to S608 added between the connector A shown in FIG. 2 and Step S313 shown in FIG. 4

Step S606 is a step where the first information processing device 101 creates a fourth prompt and inputs it to the second information processing device 102 when the processing task proceeds to the connector A, that is, the determination that the first literature does not come up (No) is made. The fourth prompt preferably includes an instruction to create a search formula including a term and a synonym for the portion needing citation in the text. Alternatively, the fourth prompt preferably includes an instruction to provide a keyword including a term and a synonym for the portion needing citation in the text.

Step S607 is a step where the second information processing device 102 outputs an answer to the input fourth prompt.

Step S608 is a step where the input/output device 103 displays the search formula including a term and a synonym and the keyword including a term and a synonym for the portion needing citation in the text.

The user can obtain the third literature from the Internet, another database, or the like with reference to such information, whereby the processing task can proceed to Step S313.

At least part of this embodiment can be implemented as appropriate in combination with the other embodiment described in this specification.

### Embodiment 2

In this embodiment, hardware that can be used for the cited literature suggestion system of one embodiment of the present invention will be described in detail.

### First information processing device 101

The first information processing device 101 has a function of performing processing with use of data supplied from the input/output device 103, the second information processing device 102, the memory device 104, and the like. The first information processing device 101 can supply processing results to the input/output device 103, the second information processing device 102, the memory device 104, or the like.

A transistor including a metal oxide in a channel formation region may be used in the first information processing device 101. Since the transistor has an extremely low off-state current, with use of the transistor as a switch for retaining electric charge (data) which flows into a capacitor serving as a memory element, a long data retention period can be ensured. When at least one of a register and a cache memory included in the first information processing device 101 has such a feature, the first information processing device 101 can be operated only when needed, and otherwise can be off while information processed immediately before turning off the first information processing device 101 is stored in the memory element. In other words, normally-off computing is possible, and power consumption of the cited literature suggestion system can be reduced.

In this specification and the like, a transistor including an oxide semiconductor in a channel formation region is referred to as an oxide semiconductor transistor (OS transistor). A channel formation region of an OS transistor preferably includes a metal oxide.

The metal oxide included in the channel formation region preferably contains indium (In). When the metal oxide included in the channel formation region is a metal oxide containing indium, the carrier mobility (electron mobility) of the OS transistor is high. For example, indium oxide (InOx) or indium gallium zinc oxide (In-Ga-Zn oxide, also referred to as "IGZO") can be used for the channel formation region. The metal oxide included in the channel formation region preferably contains an element M. The element M is preferably at least one of aluminum (Al), gallium (Ga), and tin (Sn). Other elements that can be used as the element M are boron (B), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that two or more of the above elements can be used in combination as the element M in some cases. The element M is, for example, an element that has high bonding energy with oxygen. The element M is, for example, an element that has higher bonding energy with oxygen than indium is. The metal oxide in the channel formation region preferably contains zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium but contains any of zinc, gallium, and tin (e.g., zinc tin oxide or gallium tin oxide).

Furthermore, a transistor including silicon in a channel formation region may be used in the first information processing device 101.

In the first information processing device 101, a transistor including an oxide semiconductor in a channel formation region and a transistor including silicon in a channel formation region may be used in combination.

The first information processing device 101 includes, for example, an arithmetic circuit, a central processing unit (CPU), or the like.

The first information processing device 101 may include a microprocessor such as a digital signal processor (DSP) or a graphics processing unit (GPU). The microprocessor may be configured with a programmable logic device (PLD) such as a field programmable gate array (FPGA) or a field programmable analog array (FPAA). The first information processing device 101 can interpret and execute instructions from various programs with use of a processor to process various kinds of data and control programs. The programs to be executed by the processor are stored in at least one of the second information processing device 102 and a memory region of the processor.

The first information processing device 101 may include a main memory. The main memory includes at least one of a volatile memory such as a random access memory (RAM) and a nonvolatile memory such as a read only memory (ROM).

For example, a dynamic random access memory (DRAM) or a static random access memory (SRAM) is used as the RAM, in which case a virtual memory space is assigned to the RAM to be used as a work space for the first information processing device 101.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultraviolet erasable programmable read only memory (UV-EPROM) that can erase stored data by irradiation with ultraviolet rays, an electrically erasable programmable read only memory (EEPROM), and a flash memory.

### Second information processing device 102

The second information processing device 102 has a function of performing processing using a foundation model. Thus, the second information processing device 102 has a function of storing the foundation model. The second information processing device 102 preferably has higher processing performance than the first information processing device 101. The second information processing device 102 includes an arithmetic circuit or a CPU, for example. The second information processing device 102 may include a microprocessor such as a DSP or a GPU.

The second information processing device 102 includes at least one of a volatile memory and a nonvolatile memory. For example, the second information processing device 102 may include a volatile memory such as a DRAM or an SRAM. For example, the second information processing device 102 may include a nonvolatile memory such as a resistive random access memory (ReRAM), a phase change random access memory (PRAM), a ferroelectric random access memory (FeRAM), or a magnetoresistive random access memory (MRAM), or a flash memory. In some cases, the second information processing device 102 may include a storage media drive such as a hard disk drive (HDD) or a solid state drive (SSD).

The second information processing device 102 can include the transistor including a metal oxide in a channel formation region described in the first information processing device 101. Since the OS transistor has an extremely low off-state current, a memory including the transistor can be suitably used as a nonvolatile memory for retaining analog data. When weighted data in a neural network is held in an analog memory, a plurality of product-sum operations can be executed in parallel using an analog arithmetic circuit. Thus, when the analog memory including the transistor including a metal oxide is used for the second information processing device 102, power consumption in processing using the foundation model can be significantly reduced.

### Memory device 104

The memory device 104 includes at least one of a volatile memory and a nonvolatile memory described in the second information processing device 102.

Note that the first information processing device 101, the second information processing device 102, and the memory device 104 are not necessarily separated from each other. For example, an information processing device having functions of the first information processing device 101, the second information processing device 102, and the memory device 104 may be used.

Note that memories included in the first information processing device 101, the second information processing device 102, and the memory device 104 can each be regarded as an example of a non-transitory computer-readable storage medium.

### Network 120

The network 120 has a function of transmitting various kinds of data. Data can be transmitted and received among the input/output device 103, the input device 130, the output device 140, the first information processing device 101, the second information processing device 102, the memory device 104, and the like via the network 120. For example, the text, the prompt, the experimental data, the input, the output, and the like are transmitted and received via a transmission path.

At least part of this embodiment can be implemented as appropriate in combination with the other embodiment described in this specification.

This application is based on Japanese Patent Application Serial No. 2024-187301 filed with Japan Patent Office on October 24, 2024, the entire contents of which are hereby incorporated by reference.

What is claimed is:

1. A system comprising:
an input/output device configured to receive a first text;
a memory device;
a first information processing device; and
a second information processing device,
wherein the memory device is configured to store a plurality of second texts,
wherein the second information processing device is configured to perform processing using a foundation model,
wherein the first information processing device is configured to perform a search on the plurality of second texts stored in the memory device using a first query,
wherein the first query comprises a portion of the first text requiring a citation,
wherein the first information processing device is configured to create a first prompt comprising a first text of the plurality of second texts,
wherein the first text of the plurality of second texts is a text found in the search on the plurality of second texts,
wherein the first information processing device is configured to output the first prompt to the second information processing device,
wherein the first prompt comprises an instruction to confirm whether or not the first text of the plurality of second texts is appropriate as cited literature for the portion of the first text requiring a citation, to confirm whether a portion relating to the portion of the first text requiring a citation in the first text of the plurality of second texts is cited from a third text when the first text of the plurality of second text has been confirmed to be appropriate, and to provide information on the third text when the third text has been confirmed to be the source for the cited portion relating to the portion of the first text requiring a citation in the first text of the plurality of second texts, and
wherein the input/output device is configured to display the portion of the first text requiring a citation, the first text of the plurality of second texts, and the third text.

2. The system according to claim 1,
wherein the first information processing device is further configured to form a second prompt and to input the second prompt to the second information processing device, and
wherein the second prompt comprises an instruction to extract a portion requiring a citation from the text.

3. The system according to claim 2,
wherein the input/output device is configured to display a suggestion provided by the first information processing device and to receive literature, and
wherein the first information processing device is configured to provide the input/output device with a suggestion for obtaining third literature and to register the third literature in the memory device.

4. The system according to claim 3,
wherein the input/output device is further configured to receive a plurality of pieces of experimental data,
wherein the first information processing device is configured to create a third prompt with use of the plurality of pieces of received experimental data and to input the third prompt to the second information processing device,
wherein the third prompt comprises an instruction to create an introduction suitable for an academic paper presenting the plurality of pieces of experimental data from information included in the plurality of pieces of experimental data, and
wherein the input/output device is configured to display the instruction created by the second information processing device.

5. The system according to claim 4, wherein the introduction is used as text.

6. The system according to claim 5,
wherein the first information processing device is configured to search the memory device with use of the portion requiring a citation in the text as a query, to create a fourth prompt when no literature comes up, and to input the fourth prompt to the second information processing device,
wherein the fourth prompt comprises an instruction to create a search formula comprising a term and a synonym for the portion requiring a citation in the text, and
wherein the first information processing device is configured to provide the input/output device with a suggestion for obtaining the third literature with use of the search formula created by the second information processing device and to register the third literature in the memory device.

7. A system comprising:
an input/output device configured to receive a first text;
a memory device;
a first information processing device comprising an arithmetic circuit; and
a second information processing device comprising at least one of a central processing unit and an arithmetic circuit and at least one of a volatile memory and a nonvolatile memory,
wherein the memory device is configured to store a plurality of second texts,
wherein the second information processing device is configured to perform processing using a foundation model,
wherein the first information processing device is configured to perform a search on the plurality of second texts stored in the memory device using a first query,
wherein the first query comprises a portion of the first text requiring a citation,
wherein the first information processing device is configured to create a first prompt comprising a first text of the plurality of second texts,
wherein the first text of the plurality of second texts is a text found in the search on the plurality of second texts,
wherein the first information processing device is configured to output the first prompt to the second information processing device,
wherein, based on the first prompt, the second information processing device is configured to confirm whether or not the first text of the plurality of second texts is appropriate as cited literature for the portion of the first text requiring a citation, to confirm whether a portion relating to the portion of the first text requiring a citation in the first text of the plurality of second texts is cited from a third text when the second information processing device has confirmed that the first text of the plurality of second text is appropriate, and to provide information on the third text when the second information processing device has confirmed that the third text is the source for the cited portion relating to the portion of the first text requiring a citation in the first text of the plurality of second texts, and
wherein the input/output device is configured to display the portion of the first text requiring a citation, the first text of the plurality of second texts, and the third text.

8. A system comprising:
an input/output device configured to receive a first text;
a memory device;
a first information processing device comprising at least one of a transistor including an oxide semiconductor in a channel formation region and a transistor including silicon in a channel formation region; and
a second information processing device,
wherein the memory device is configured to store a plurality of second texts,
wherein the second information processing device is configured to perform processing using a foundation model,
wherein the first information processing device is configured to perform a search on the plurality of second texts stored in the memory device using a first query,
wherein the first query comprises a portion of the first text requiring a citation,
wherein the first information processing device is configured to create a first prompt comprising a first text of the plurality of second texts,
wherein the first text of the plurality of second texts is a text found in the search on the plurality of second texts,
wherein the first information processing device is configured to output the first prompt to the second information processing device,
wherein, based on the first prompt, the second information processing device is configured to confirm whether or not the first text of the plurality of second texts is appropriate as cited literature for the portion of the first text requiring a citation, to confirm whether a portion relating to the portion of the first text requiring a citation in the first text of the plurality of second texts is cited from a third text when the second information processing device has confirmed that the first text of the plurality of second text is appropriate, and to provide information on the third text when the second information processing device has confirmed that the third text is the source for the cited portion relating to the portion of the first text requiring a citation in the first text of the plurality of second texts, and
wherein the input/output device is configured to display the portion of the first text requiring a citation, the first text of the plurality of second texts, and the third text.
